(19) United States
(12) Patent Application Publication
(10) Pub. No.: US 2013/0285571 A1
(43) Pub. Date: Oct. 31, 2013

(54) LED Backlight drive circuit, LCD Device and Driving Method

(71) Applicants: Fei Li, Shenzhen (CN); Xinming Gao, Shenzhen (CN); Xiang Yang, Shenzhen (CN)

(72) Inventors: Fei Li, Shenzhen (CN); Xinming Gao, Shenzhen (CN); Xiang Yang, Shenzhen (CN)

(21) Appl. No.: 13/515,284

(22) PCT Filed: Apr. 28, 2012
(86) PCT No.: PCT/CN12/74904

§ 371 Date: Jun. 11, 2012

(30) Foreign Application Priority Data
Apr. 26, 2012 (CN) 201210131423.8

(51) Int. Cl. H05B 37/02; H05B 37/00

(52) U.S. Cl. 315/297; 315/312

(57) ABSTRACT

The invention provides an LED backlight drive circuit, an LCD device and a driving method. The LED backlight drive circuit comprises a plurality of LED lightbars which are arranged in parallel connection, and a detection module; a comparison unit is arranged in said detection module, the comparison ends of the comparison unit are respectively coupled to the output ends of the LED lightbars, and the reference end thereof is coupled with an adjustable reference voltage module. In the invention, because the comparison unit is used, and the reference end of the comparison unit is coupled to an adjustable reference voltage module, different reference voltages are selected in accordance with different output end voltages of the LED lightbars of the LCD device. If the voltage difference between the output end voltage of the LED lightbar and the reference voltage is controlled within a reasonable range, the comparison accuracy can be effectively improved. The maximum voltage difference of the LED lightbar is fed back to the power source end of the drive circuit to regulate the output of the power source.

### TECHNICAL FIELD

The invention relates to the field of liquid crystal displays (LCDs), and more particularly to a light emitting diode (LED) backlight drive circuit, an LCD device, and a driving method.

### BACKGROUND

As shown in FIG. 1, a conventional LCD backlight source includes multiple strings of LED lightbars, and a voltage difference exists between every two strings of LED lightbars. Therefore, the aim of designing a backlight source is to find a string of LED lightbars with the maximum voltage difference for design, to meet optical brightness and error requirements. The present method of finding the LED lightbars with the maximum voltage difference is that: a multipath comparator is nested inside an IC; the multipath comparator includes a reference end, and a plurality of comparison ends; the reference end is connected to a fixed reference voltage, and the comparison ends are respectively connected with the output ends of the LED lightbars. The multipath comparator compares the LED lightbars in pairs to find the string of LED lightbars with the maximum voltage difference to feed back the voltage difference to the power source end. However, the technical scheme has poor accuracy of adjustment.

### SUMMARY

In view of the above-described problems, the aim of the invention is to provide an LED backlight drive circuit, an LCD device and a driving method thereof capable of improving dimming accuracy.

The aim of the invention is achieved by the following technical scheme.

An LED backlight drive circuit comprises a plurality of LED lightbars which are arranged in parallel connection, and a detection module; a comparison unit is arranged in the detection module, comparison ends of the comparison unit are respectively coupled to the output ends of the LED lightbars, and a reference end thereof is coupled with an adjustable reference voltage module.

Preferably, the comparison unit comprises a plurality of comparators, the comparison end of each comparator is correspondingly coupled to the output end of each LED lightbar, and the reference ends thereof are mutually connected and then coupled to an adjustable reference voltage module. The comparison unit is divided into a plurality of comparators, and each comparator only collects the voltage of one LED lightbar; thus, the charge burden is reduced, and the heating value is reduced. In addition, the heat of the comparison unit is shared onto a plurality of separate comparators, thereby increasing the heat dissipation efficiency, and favoring the heat dissipation of the detection module.

Preferably, the detection module further comprises a voltage regulation module; the output end of each comparator is respectively connected to the voltage regulation module. The voltage regulation module compares the voltages at the output ends of any two LED lightbars, and feeds back a group of values of maximum voltage difference to the power source end of the LED backlight drive circuit. In the technical scheme, the comparators only compare the voltage difference between the voltage of the corresponding LED lightbar and the reference voltage, and then transfer the voltage difference to the voltage regulation module. The voltage regulation module calculates the LED lightbar strip with the maximum voltage difference, and then feeds back the voltage difference to the power source end of the drive circuit to be regulated and output, favoring the circuit structure of the comparison unit.

Preferably, the adjustable reference voltage module comprises a first resistor and a second resistor which are in series connection; one end of the first resistor is connected with a fixed reference voltage, and the other end is connected with the second resistor; one end of the second resistor is connected with the first resistor, and the other end is connected with the ground; the reference end of the comparison unit is coupled between the first resistor and the second resistor. This is a regulation mode of resistor voltage division. Thus, the input voltage of the adjustable reference voltage module can be unchanged, and the reference voltage can be regulated by regulating the resistance ratio between the first resistor and the second resistor.

Preferably, the second resistor is an adjustable resistor. In the technical scheme, both the input voltage value of the adjustable reference voltage module and the resistance value of the first resistor can be unchanged, and the reference voltage can be changed by only regulating the resistance value of the second resistor, thereby favoring the generalization of the circuit.

Preferably, the adjustable reference voltage module comprises an adjustable resistor; one end of the adjustable resistor is connected with the fixed reference voltage, and the other end is connected with the ground; the reference end of the comparison unit is coupled to the output end of the adjustable resistor. The voltage can be directly regulated by one resistor; thus, the circuit is simple, the regulation range is wide, and the generality is high.

Preferably, the comparison unit comprises a plurality of comparators, the comparison end of each comparator is correspondingly coupled to the output end of each LED lightbar, and the reference ends thereof are mutually connected. The adjustable reference voltage module comprises a first resistor and a second resistor which are in series connection; one end of the first resistor is connected with the fixed reference voltage, and the other end is connected with the second resistor; one end of the second resistor is connected with the first resistor, and the other end is connected with the ground; the reference end of each comparator is coupled between the first resistor and the second resistor. The detection module further comprises a voltage regulation module; the output end of each comparators are respectively connected to the voltage regulation module. The voltage regulation module compares the voltages at the output ends of any two LED lightbars, and feeds back a group of values of maximum voltage difference to the power source end of the LED backlight drive circuit. This is a specific LED backlight drive circuit.

An LCD device comprises an LED backlight drive circuit mentioned above.

A driving method of the LED backlight drive circuit comprises the following steps:

A: Regulating the reference voltage of the comparison unit by the adjustable reference voltage module; and

B: Collecting the voltages at the output ends of the LED lightbars by using the comparison unit as comparison voltages, respectively comparing the comparison voltages with the reference voltage to find the LED lightbar with the maximum voltage difference, and feeding back the voltage difference to the power source end of the LED backlight drive circuit.

Preferably, in the step B, the comparison unit comprises a plurality of comparators. Each comparator collects the voltage of the output end of one LED lightbar, compares the collected comparison voltages with the reference voltage to find the LED lightbar with the maximum voltage difference, and feeds back the voltage difference to the power source end of the LED backlight drive circuit. The comparison unit is divided into a plurality of comparators, and each comparator only collects the voltage of one LED lightbar; thus, the charge burden is reduced, and the heating value is reduced. In addition, the heat of the comparison unit is shared onto a plurality of separate comparators, thereby increasing the heat dissipation efficiency, and favoring the heat dissipation of the detection module.

In the invention, because the comparison unit is used, and the reference end of the comparison unit is coupled to an adjustable reference voltage module, different reference voltages are selected in accordance with different output end voltages of the LED lightbars of the LCD device; thus, the regulation range is wide. If the voltage difference between the output end voltage of the LED lightbar and the reference voltage is controlled within a reasonable range, the comparison accuracy can be effectively improved, and the efficiency can be increased. The maximum voltage difference of each LED lightbar is fed back to the power source end of the drive circuit to regulate the output of the power source.

### BRIEF DESCRIPTION OF FIGURES

FIG. 1 is a schematic diagram of a conventional LED backlight drive circuit;

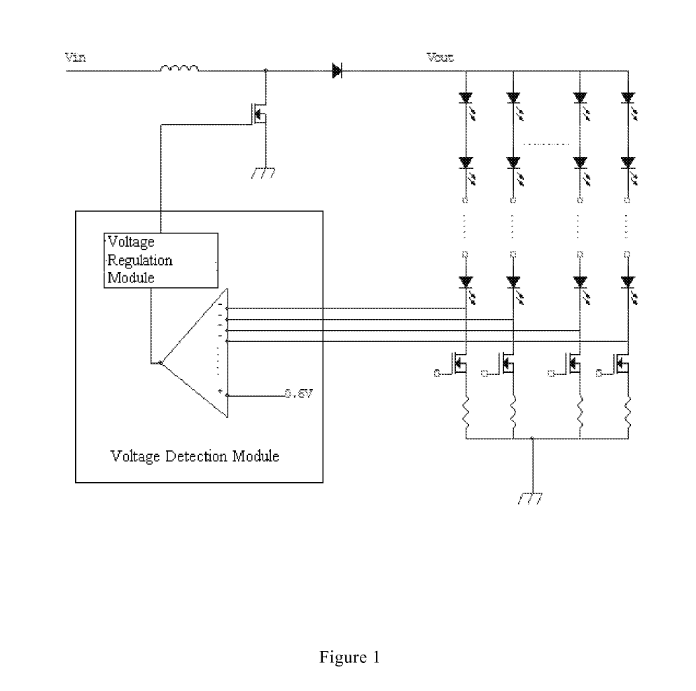

FIG. 2 is a schematic diagram of a circuit principle of a first example of the invention;

FIG. 3 is a schematic diagram of a circuit principle of a second example of the invention; and

FIG. 4 is a schematic diagram of a circuit principle of a third example of the invention.

### DETAILED DESCRIPTION

The invention will further be described in detail in accordance with the figures and the preferable examples.

An LCD device comprises an LCD panel, an a backlight module used for providing a light source for the LCD panel; the backlight module of the invention comprises an LED backlight drive circuit; the LED backlight drive circuit comprises a plurality of LED lightbars which are arranged in parallel connection, and a detection module; a comparison unit is arranged in the detection module, the comparison ends of the comparison unit are respectively coupled to the output ends of LED lightbars, and the reference end thereof is coupled with an adjustable reference voltage module.

In the invention, because the comparison unit is used, and the reference end of the comparison unit is coupled to an adjustable reference voltage module, different reference voltage values are selected in accordance with different output end voltages of the LED lightbars of the LCD device. If the voltage difference between the output end voltage of the LED lightbar and the reference voltage is controlled within a reasonable range, the comparison accuracy can be effectively improved. The maximum voltage difference of the LED lightbar is fed back to the power source end of the drive circuit to regulate the output of the power source. The invention will further be described in detail in accordance the examples.

### EXAMPLE 1

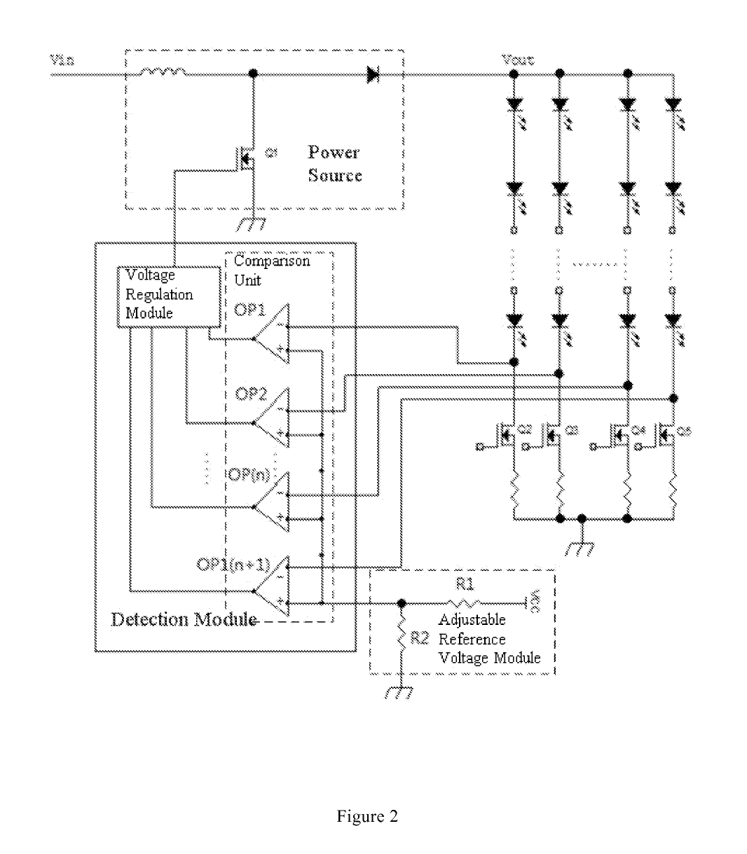

As shown in FIG. 2, the comparison unit comprises a plurality of comparators OP1−OP(n+1); the comparison end of each comparator is correspondingly coupled to the output end of each LED light bar, and the reference ends thereof are mutually connected. The adjustable reference voltage module comprises a first resistor R1, and a second resistor R2 which are in series connection; one end of the first resistor R1 is connected with the fixed reference voltage, and the other end is connected with the second resistor R2; one end of the second resistor R2 is connected with the first resistor R1, and the other end is connected with the ground; the reference end of each comparator is coupled between the first resistor R1 and the second resistor R2. The comparison unit is divided into a plurality of comparators, and each comparator only collects the voltage of one LED lightbar; thus, the charge burden is reduced, and the heating value is reduced. In addition, the heat of the comparison unit is shared onto a plurality of separate comparators, thereby increasing the heat dissipation efficiency, and favoring the heat dissipation of the detection module.

The detection module further comprises a voltage regulation module; the output ends of all the comparators are respectively connected to the voltage regulation module. The voltage regulation module compares the voltages at the output ends of any two LED lightbars, and feeds back a group of maximum voltage difference to the power source end of the LED backlight drive circuit. The comparators only compare the voltage difference between the voltage of the corresponding LED lightbar and the reference voltage, and then transfer the voltage difference to the voltage regulation module. The voltage regulation module calculates the LED lightbar strip with the maximum voltage difference, and then feeds back the voltage difference to the power source end of the drive circuit to be regulated and output, thereby favoring the circuit structure of the comparison unit. Optionally, a calculation voltage is separately set, is transmitted to the voltage regulation module after being compared with the voltage output by each comparator, and then is fed back to the power source end by the voltage regulation module to be regulated and output.

The invention employs a regulation mode of resistor voltage division. Thus, the input voltage of the adjustable reference voltage module can be unchanged, and the reference voltage can be regulated by regulating the resistance ratio between the first resistor R1 and the second resistor R2.

### EXAMPLE 2

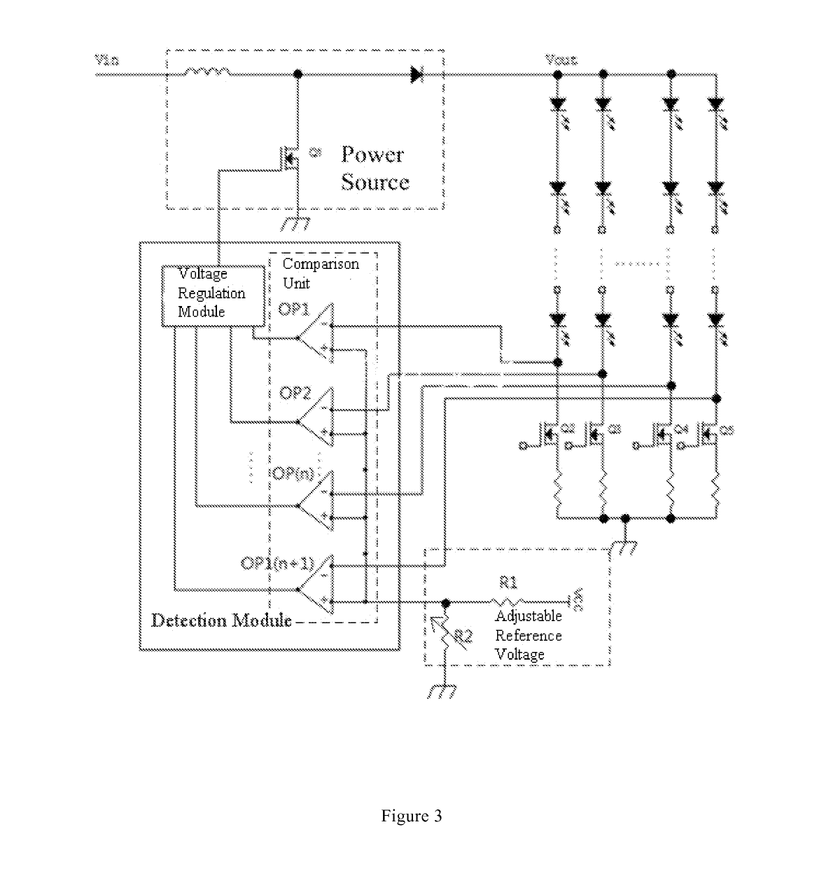

As shown in FIG. 3, the comparison unit comprises a plurality of comparators OP1−OP(n+1); the comparison end of each comparator is correspondingly coupled to the output end of each LED light bar, and the reference ends thereof are mutually connected. The adjustable reference voltage module comprises a first resistor R1 and a second resistor R2 which are in series connection; one end of the first resistor R1 is connected with the fixed reference voltage, and the other end is connected with the second resistor R2; the second R2 is an adjustable resistor, one end thereof is connected with the first resistor R1, and the other end is connected with the ground; and the reference end of each comparator is coupled between the first resistor R1 and the second resistor R2. The comparison unit is divided into a plurality of comparators, and each comparator only collects the voltage of one LED lightbar; thus, the charge burden is reduced, and the heating quantity is reduced. In addition, the heat of the comparison unit is shared onto a plurality of separate comparators, thereby increasing the heat dissipation efficiency, and favoring the heat dissipation of the detection module.

The detection module further comprises a voltage regulation module; the output ends of all the comparators are respectively connected to the voltage regulation module. The voltage regulation module compares the voltages at the output ends of any two LED lightbars, and feeds back a group of values of maximum voltage difference to the power end of the LED backlight drive circuit. The comparators only compare the voltage difference between the voltage of the corresponding LED lightbar and the reference voltage, and then transfer the voltage difference to the voltage regulation module. The voltage regulation module calculates the LED lightbar strip with the maximum voltage difference, and then feeds back the voltage difference to the power source end of the drive circuit to be regulated and output, thereby favoring the simplification of the circuit structure of the comparison unit. Optionally, a calculation voltage is separately set, is transmitted to the voltage regulation module after being compared with the voltage output by each comparator, and then is fed back to the power source end by the voltage regulation module to be regulated and output.

In the example, both the input voltage value of the adjustable reference voltage module and the resistance value of the first resistor R1 can be unchanged, and the reference voltage value can be changed by only regulating the resistance value of the second resistor R2, thereby favoring the generalization of the circuit.

### EXAMPLE 3

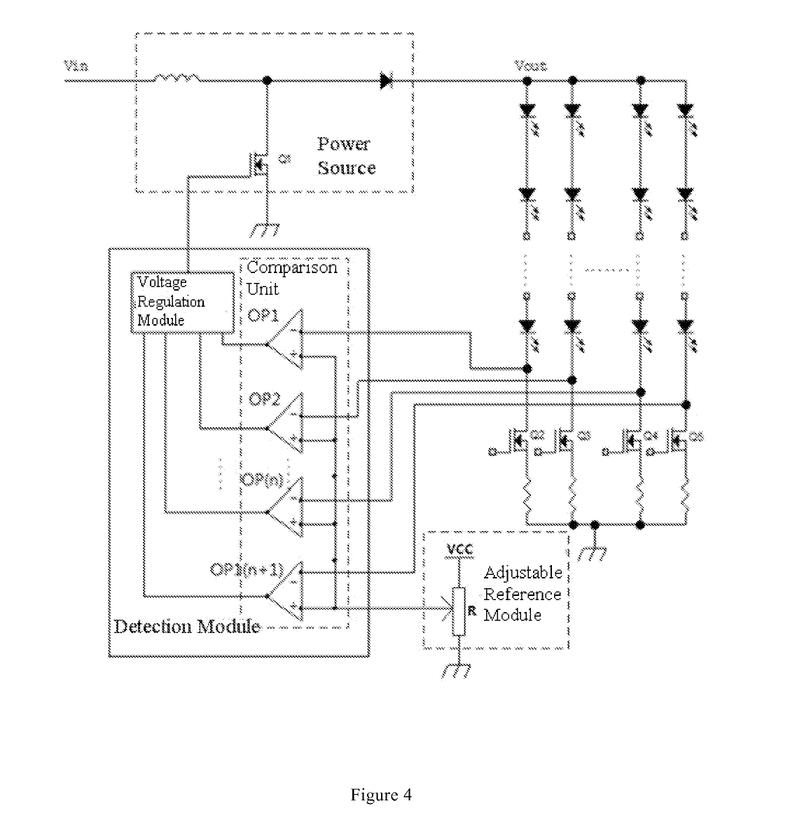

As shown in FIG. 4, the comparison unit comprises a plurality of comparators OP1−OP(n+1); the comparison end of each comparator is correspondingly coupled to the output end of each LED light bar, and the reference ends thereof are mutually connected. The adjustable reference voltage module comprises an adjustable resistor R; one end of the adjustable resistor R is connected with the fixed reference voltage, and the other end is connected with the ground; and the reference end of each comparator is coupled to the output end of the adjustable resistor R. The comparison unit is divided into a plurality of comparators, and each comparator is only used for collecting the voltage of one LED lightbar; thus, the charge burden is reduced, and the heating value is reduced. In addition, the heat of the comparison unit is shared to a plurality of separate comparators, thereby increasing the heat dissipation efficiency, and favoring the heat dissipation of the detection module.

The detection module further comprises a voltage regulation module; the output end of each the comparators are respectively connected to the voltage regulation module. The voltage regulation module compares the voltages at the output ends of any two LED lightbars, and feeds back a group of values of maximum voltage difference to the power source end of the LED backlight drive circuit. The comparators only compare the voltage difference between the voltage of the corresponding LED lightbar and the reference voltage, and then transfer the voltage value to the voltage regulation module. The voltage regulation module calculates the LED lightbar strip with the maximum voltage difference, and then feeds back the voltage difference to the power source end of the drive circuit to be regulated and output, thereby favoring the simplification of the circuit structure of the comparison unit. Optionally, a calculation voltage is separately set, is transmitted to the voltage regulation module after being compared with the voltage output by each comparator, and then is fed back to the power source end by the voltage regulation module to be regulated and output.

In the example, the voltage can be directly regulated by one resistor; thus, the circuit is simple, the regulation range is wide, and the generality is high.

The invention further provides a driving method of the LED backlight drive circuit, comprising the following steps:

A: Regulating the reference voltage of the comparison unit by the adjustable reference voltage module; and

B: Collecting the voltages at the output ends of the LED lightbars by the comparison unit as comparison voltages, respectively comparing the comparison voltages with the reference voltage to find the LED lightbar with the maximum voltage difference, and feeding back the voltage difference to the power source end of the LED backlight drive circuit.

In the step B, the comparison unit comprises a plurality of comparators. Each comparator collects the voltage of the output end of one LED lightbar, compares the collected comparison voltages with the reference voltage to find the LED lightbar with the maximum voltage difference, and feeds back the voltage difference to the power source end of the LED backlight drive circuit. The comparison unit is divided into a plurality of comparators, and each comparator only collects the voltage of one LED lightbar; thus, the charge burden is reduced, and the heating value is reduced. In addition, the heat of the comparison unit is shared to a plurality of separate comparators, thereby increasing the heat dissipation efficiency, and favoring the heat dissipation of the detection module.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LED backlight drive circuit, comprising: a plurality of LED lightbars which are arranged in parallel connection, and a detection module; wherein a comparison unit is arranged in said detection module, the comparison ends of said comparison unit are respectively coupled to the output ends of the LED lightbars, and the reference end thereof is coupled with an adjustable reference voltage module.

2. The LED backlight drive circuit of claim 1, wherein said comparison unit comprises a plurality of comparators; the comparison end of each comparator is correspondingly coupled to the output end of each LED lightbar, and the reference ends thereof are mutually connected and then coupled to an adjustable reference voltage module.

3. The LED backlight drive circuit of claim 2, wherein said detection module further comprises a voltage regulation module; the output end of each comparator is respectively connected to said voltage regulation module; said voltage regulation module compares the voltages at the output ends of any two LED lightbars, and feeds back a group of values of maximum voltage difference to the power source end of said LED backlight drive circuit.

4. The LED backlight drive circuit of claim 1, wherein said adjustable reference voltage module comprises a first resistor and a second resistor which are in series connection; one end of said first resistor is connected with a fixed reference voltage, and the other end is connected with said second resistor; one end of said second resistor is connected with said first resistor, and the other end is connected with the ground; and the reference end of said comparison unit is coupled between said first resistor and said second resistor.

5. The LED backlight drive circuit of claim 4, wherein said second resistor is an adjustable resistor.

6. The LED backlight drive circuit of claim 1, wherein said adjustable reference voltage module comprises an adjustable resistor; one end of said adjustable resistor is connected with the fixed reference voltage, and the other end is connected with the ground; and the reference end of said comparison unit is coupled to the output end of said adjustable resistor.

7. The LED backlight drive circuit of claim 1, wherein said comparison unit comprises a plurality of comparators; the comparison end of each comparator is correspondingly coupled to the output end of each LED lightbar, and the reference ends thereof are mutually connected; said adjustable reference voltage module comprises a first resistor and a second resistor which are in series connection; one end of said first resistor is connected with the fixed reference voltage, and the other end is connected with said second resistor; one end of said second resistor is connected with said first resistor, and the other end is connected with the ground; the reference end of each said comparator is coupled between said first resistor and said second resistor; said detection module further comprises a voltage regulation module; the output end of each said comparator is respectively connected to said voltage regulation module; said voltage regulation module compares the voltages at the output ends of any two LED lightbars, and feeds back a group of values of maximum voltage difference to the power source end of said LED backlight driver circuit.

8. An LCD device, comprising: an LED backlight drive circuit; wherein said LED backlight drive circuit comprises a plurality of LED lightbars which are arranged in parallel connection, and a detection module; a comparison unit is arranged in said detection module, the comparison ends of said comparison unit are respectively coupled to the output ends of the LED lightbars, and the reference end thereof is coupled with an adjustable reference voltage module.

9. The LCD device of claim 8, wherein said comparison unit comprises a plurality of comparators; the comparison end of each said comparator is correspondingly coupled to the output end of each LED lightbar, and the reference ends thereof are mutually connected and then coupled to an adjustable reference voltage module.

10. The LCD device of claim 9, wherein said detection module further comprises a voltage regulation module; the output end of each said comparator is connected to said voltage regulation module; said voltage regulation module compares the voltages at the output ends of any two LED lightbars, and feeds back a group of values of maximum voltage difference to the power source end of said LED backlight drive circuit.

11. The LCD device of claim 1, wherein said adjustable reference voltage module comprises a first resistor and a second resistor which are in series connection; one end of said first resistor is connected with the fixed reference voltage, and the other end is connected with said second resistor;
one end of said second resistor is connected with said first resistor, and the other end is connected with the ground; and the reference end of said comparison unit is coupled between said first resistor and said second resistor.

12. The LCD device of claim 11, wherein said second resistor is an adjustable resistor.

13. The LCD device of claim 8, wherein said adjustable reference voltage module comprises an adjustable resistor; one end of said adjustable resistor is connected with the fixed reference voltage, and the other end is connected with the ground; and the reference end of said comparison unit is coupled to the output end of said adjustable resistor.

14. The LCD device of claim 8, wherein said comparison unit comprises a plurality of comparators; the comparison end of each said comparator is correspondingly coupled to the output end of each LED lightbar, and the reference ends thereof are mutually connected; said adjustable reference voltage module comprises a first resistor and a second resistor which are in series connection; one end of said first resistor is connected with the fixed reference voltage, and the other end is connected with said second resistor; one end of said second resistor is connected with said first resistor, and the other end is connected with the ground; the reference end of each said comparator is coupled between said first resistor and said second resistor; said detection module further comprises a voltage regulation module; the output end of each said comparator is respectively connected to said voltage regulation module; said voltage regulation module compares the voltages at the output ends of any two LED lightbars, and feeds back a group of values of maximum voltage difference to the power source end of said LED backlight drive circuit.

15. A driving method of the LED backlight drive circuit, comprising: the following steps:
A: Regulating the reference voltage of said comparison unit by said adjustable reference voltage module;
B: Collecting the voltages at the output ends of said LED lightbars by said comparison unit as comparison voltages, respectively comparing said comparison voltages with said reference voltage to find the LED lightbar with the maximum voltage difference, and feeding back said voltage difference to the power end of said LED backlight drive circuit.

16. The driving method of the LED backlight drive circuit of claim 15, wherein in said step B, said comparison unit comprises a plurality of comparators; each said comparator collects the voltage at the output end of one LED lightbar, compares the collected comparison voltages with said reference voltage to find the LED lightbar with the maximum voltage difference, and feeds back said voltage difference to the power source end of said LED backlight drive circuit.
